(19) United States
(12) Patent Application Publication
(10) Pub. No.: US 2009/0295863 A1
(43) Pub. Date: Dec. 3, 2009

(54) CONTINUOUS INKJET PRINTHEAD NOZZLE CAP

(76) Inventors: Douglas E. Schultz, Dayton, OH (US); Michael S. Hanchak, Dayton, OH (US); Robert J. Simon, Bellbrook, OH (US); Charles D. Rike, Lebanon, OH (US); Timothy T. Hare, West Carollton, OH (US)

Correspondence Address: Andrew J. Anderson;Patent Legal Staff, Eastman Kodak Company, 343 State Street, Rochester, NY, 14650-2201, US

(21) Appl. No.: 12/127,886

(22) Filed: May 28, 2008

(51) Int. Cl. B41J 2/165

(52) U.S. Cl. 347/32

(57) ABSTRACT

A printhead includes a jetting module, a catcher, a drop deflection mechanism, and a capping mechanism. The jetting module includes an array of nozzles and is operable to form liquid drops from liquid emitted through the nozzles of the nozzle array. The catcher collects some of the liquid drops. The drop deflection mechanism deflects the liquid drops such that some of the liquid drops contact the catcher while other liquid drops are allowed to contact a print media. The capping mechanism includes a capping member located between the nozzle array of the jetting module and the drop deflection mechanism. The capping member has a first position covering the nozzle array and a second position removed from the nozzle array.

### FIELD OF THE INVENTION

The present invention relates to printheads for ink jet printers and, more particularly to a protective capping apparatus for such printheads.

### BACKGROUND OF THE INVENTION

Ink jet printing technology is known. Ink jet printers are generally classified according to technology as being of the drop on demand or the continuous ink jet varieties. Drop on demand printheads have an array of nozzles with an actuator associated with each nozzle that is capable of ejecting a drop of ink or other liquid from the nozzle on demand for the placement of a drop on the print media. As the ink in the nozzles remains static in the nozzle between drop ejections, it is possible for solvent to begin to evaporate from the ink in a nozzle between drop ejections. As a result, the fluid properties (including viscosity) in the nozzle can begin to change. It is common, therefore, to use inks for such printheads that tend to be slow drying. When not printing, it is common to place a cap on the nozzle to inhibit the drying of the ink in the nozzles, as dried ink can readily clog the nozzles. It is also common to use a squeegee to rub across the nozzle plate to remove any ink or other debris from the nozzles that might adversely affect drop ejection.

Continuous ink jet printers employ fluid systems that supply ink or other liquid under pressure to the printhead. The pressurized liquid then flows from the nozzles in the form of continuous streams of liquid. As drops break off from the continuous stream, certain drops are selected as print drops while non-selected drops are non-print drops. A catcher is used to intercept the trajectory of non-print drops, while the print drops are allowed to proceed to the print media. As continuous ink jet printheads have a constant flow of ink through the nozzles during normal print operation, the inks used such printheads don't require as much humectant as drop on demand inks, leading to faster dry time and thus the ability to print at a higher speed.

The fluid systems for continuous ink jet systems have commonly employed extensive shutdown and startup sequences to ensure that nozzles don't get clogged when the printhead is not in use and that dried ink or other debris doesn't cause any of the streams of liquid to be misdirected as they flow from the nozzles. When carrying out such startup and shutdown sequences, it is common to employ a sealing member to seal against the bottom of the catcher to prevent ink from spraying or dripping form the printhead during the various sequence steps. In other systems, the printhead is located at a maintenance station during startup and shutdown sequences. Such maintenance stations include sealing members to seal against the catcher which contain ink that sprays or drips from the printhead during the various sequences steps.

While ink jet printers typically use fluids which easily re-dissolve, allowing dried ink residues on the nozzle plate to be removed during a start up procedure, ink that readily re-dissolves dried ink can come at the expense of permanence of printed documents. The use of the sealing members to seal against the lower part of the catcher, whether incorporated into the printhead or into a maintenance station, does not prevent ink from ink from drying in and around the nozzles. Additionally, typical shut down techniques leave pigment ink residue on the nozzle plate which cannot be removed with standard start up techniques.

Accordingly, there is a need for a more effective way of preventing ink from drying in and around the nozzles of a continuous ink jet printhead.

### SUMMARY OF THE INVENTION

According to one aspect of the invention, a printhead includes a jetting module including an array of nozzles, the jetting module being operable to form liquid drops from liquid emitted through the nozzles of the nozzle array, a catcher for collecting some of the liquid drops, a drop deflection mechanism for deflecting the liquid drops such that some of the liquid drops contact the catcher while other liquid drops are allowed to contact a print media, and a capping mechanism for capping the nozzle array. The capping mechanism includes a capping member located between the nozzle array of the jetting module and the drop deflection mechanism, and the capping member has a first position covering the nozzle array and a second position removed from the nozzle array. Advantageously, the capping member is in contact with the surface of the nozzle array when it is in the first position and the second position, and maintains contact with the surface of the nozzle array as it moves between positions.

According to another aspect of the invention, a method of capping a printhead includes providing a jetting module including an array of nozzles, the jetting module being operable to form liquid drops from liquid emitted through the nozzles of the nozzle array, providing a catcher for collecting some of the liquid drops, providing a drop deflection mechanism for deflecting the liquid drops such that some of the liquid drops contact the catcher while other liquid drops are allowed to contact a print media, providing a capping mechanism for capping the nozzle array, the capping mechanism including a capping member located between the nozzle array of the jetting module and the drop deflection mechanism, and moving the capping member to a first position covering the nozzle array from a second position removed from the nozzle array.

### BRIEF DESCRIPTION OF THE DRAWINGS

In the detailed description of the example embodiments of the invention presented below, reference is made to the accompanying drawings, in which:

FIG. 1 is a side view of an example embodiment of the present invention showing a nozzle cap in a position retracted from the nozzle array;

FIG. 2 is a side view of the example embodiment shown in FIG. 1 with the nozzle cap in a position covering the nozzle array;

FIG. 3 is a perspective view of an example embodiment of the present invention showing the nozzle cap in the nozzle array covering position;

FIG. 4 is a perspective view of the example embodiment shown in FIG. 3 with the nozzle cap in the retracted position;

FIG. 5 is a perspective view of the underside of the example embodiment of the present invention shown in FIGS. 3 and 4; and

FIG. 6 is a side view of an example embodiment of the present invention showing the nozzle cap in a position retracted from the nozzle array.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

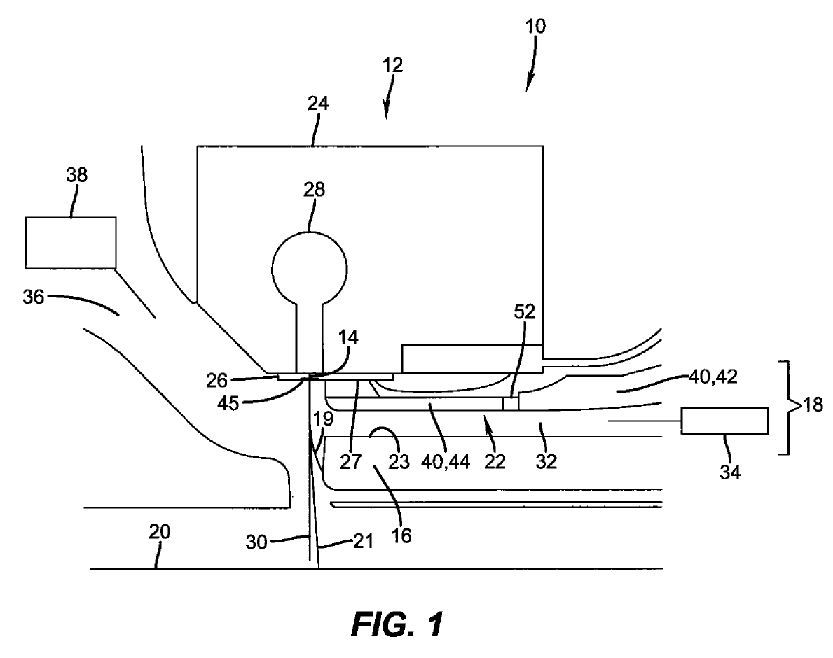

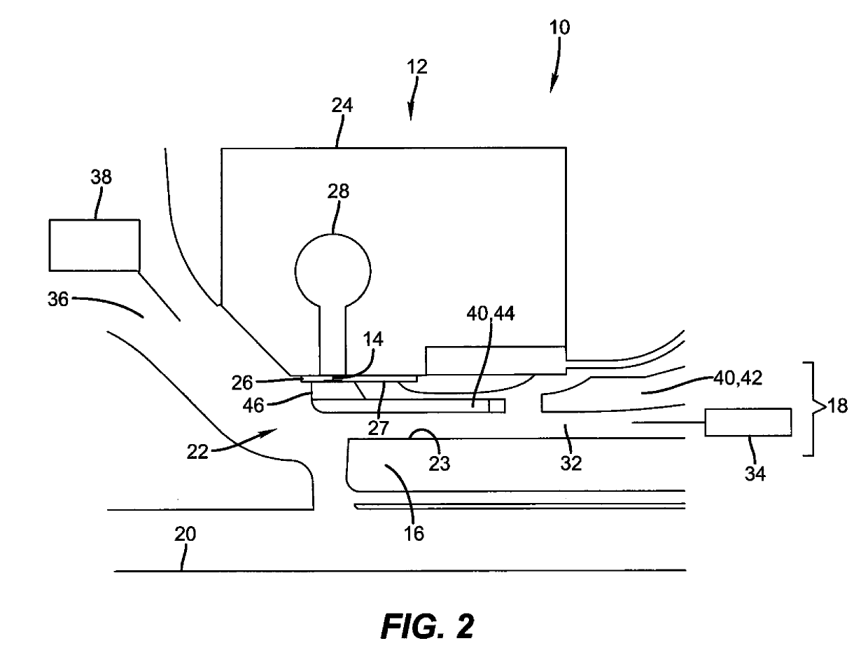

Referring to FIGS. 1 and 2, a side view of a continuous printhead of the present invention is shown. The printhead 10 includes a jetting module 12 that forms liquid drops from liquid emitted through the nozzles of a nozzle array 14, a catcher 16 for collecting some of the liquid drops, and a drop deflection mechanism 18 for deflecting the liquid drops such that some of the liquid drops 19 contact the catcher while other liquid drops 21 are allowed to contact the print media 20. The printhead 10 also includes a capping mechanism 22 for capping the nozzle array 14. A conventional fluid system, not shown, is used to supply liquid under pressure to the jetting module 12 and to retrieve liquid from the catcher 16.

The jetting module 12 includes a body 24 to which a nozzle plate 26 is attached. The body 24 includes a fluid channel 28 through which the liquid flows under pressure to the nozzle array 14 that is formed in the nozzle plate 26. The liquid flows through the nozzles of the nozzle array 14 forming a stream of continuous liquid from each nozzle. A stimulation device 45, such as a heater, a piezoelectric actuator, or an electrohydrodynamic stimulator, is associated with each nozzle of the nozzle array 14, and is actuated to selectively create drops of different sizes (large drops and small drops) from the continuous stream. These drops follow an initial drop trajectory 30.

The drop deflection mechanism 18 deflects the liquid drops such that some of the liquid drops, for example, the small drops, contact the catcher 16 while other liquid drops, for example, the large drops, are allowed to contact the print media 20. Typically, drop deflection mechanism 18 is either an electrostatic drop deflection mechanisms or a gas flow drop deflection mechanism.

In the embodiment shown in FIGS. 1 and 2, the drop deflection mechanism 18 is a gas flow drop deflection mechanism. Drop deflection mechanism 18 includes a gas flow duct 32 having walls and a gas flow source 34.

Gas flow source 34 of drop deflection mechanism 18 causes gas flow across the initial drop trajectories 30 and through the gas flow duct 32 which causes the large and small drops traveling along trajectory 30 to diverge or deflect from trajectory 30. Drop deflection mechanism 18 can also include a second gas flow duct 36 connected in fluid communication to a second gas flow source 38. Second gas flow source 38 provides a gas flow through the second gas flow duct 36 and across the drop trajectories 30 that causes the large and small drops traveling along trajectory 30 to diverge or deflect from trajectory 30.

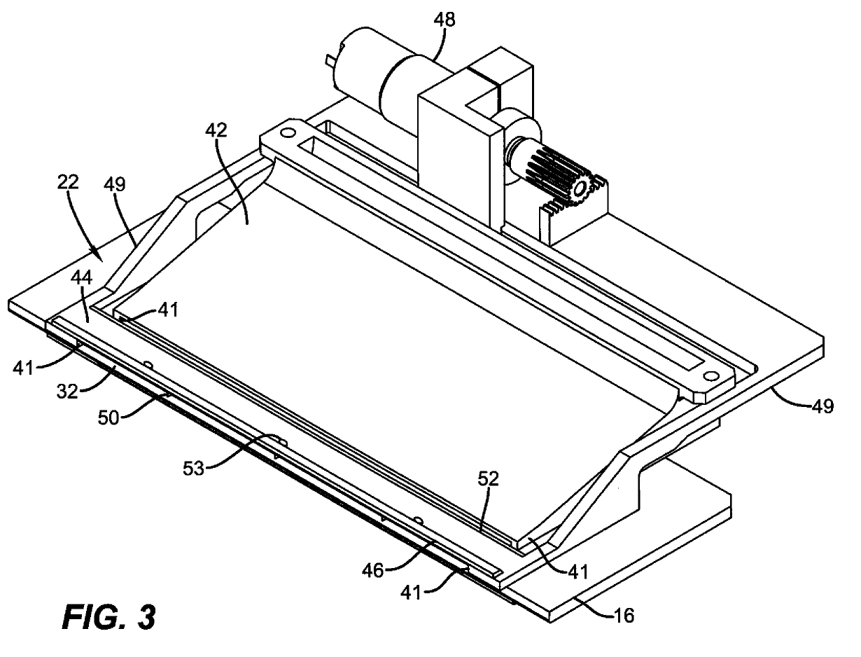

In the embodiment shown in FIGS. 1 and 2, gas flow duct 32 includes a wall 40. A wall 23 of the catcher 16 forms a second wall 23 of the gas flow duct 32. Gas flow duct 32 also includes side walls 41 (shown in FIG. 3). The wall 40 includes a fixed wall portion 42 and a moveable wall portion 44.

Capping mechanism 22, which operates to cap nozzle array 14, includes a capping member 46 located between the nozzle array 14 of the jetting module 12 and the drop deflection mechanism 18. Capping member 46 is affixed to the moveable wall portion 44 of the gas flow duct 32 of drop deflection mechanism 18. The capping member 46 can be affixed to the moveable wall portion 44 by being molded directly to the wall portion, by means of adhesive materials such as pressure sensitive tape, or mechanical means such as screws or clips that clamp a portion of the capping member.

In other embodiments of the present invention, the entire wall 40 can be moveable. In embodiments where the catcher 16 does not form a wall 23 of the gas flow duct 32, the entire drop deflection mechanism 18 or the entire gas flow duct 32 can be moveable. Thus, the moveable portion of the gas flow duct 32 can range from a portion of a wall of the gas flow duct 32 to the entire drop deflection mechanism 18, depending on the specific application contemplated and the specific configuration of the printhead 10.

Capping member 46 is made of an elastomeric material, such as rubber, or a compound including at least some elastomeric material, such as ethylene-propylene-diene monomer (EPDM) 30-35 durometer shore A. Other materials can be used, provided they are compatible with the inks and other fluids used in the printhead 10 and provide sufficient compliance to allow the capping member 46 to seal effectively against the nozzle plate 26.

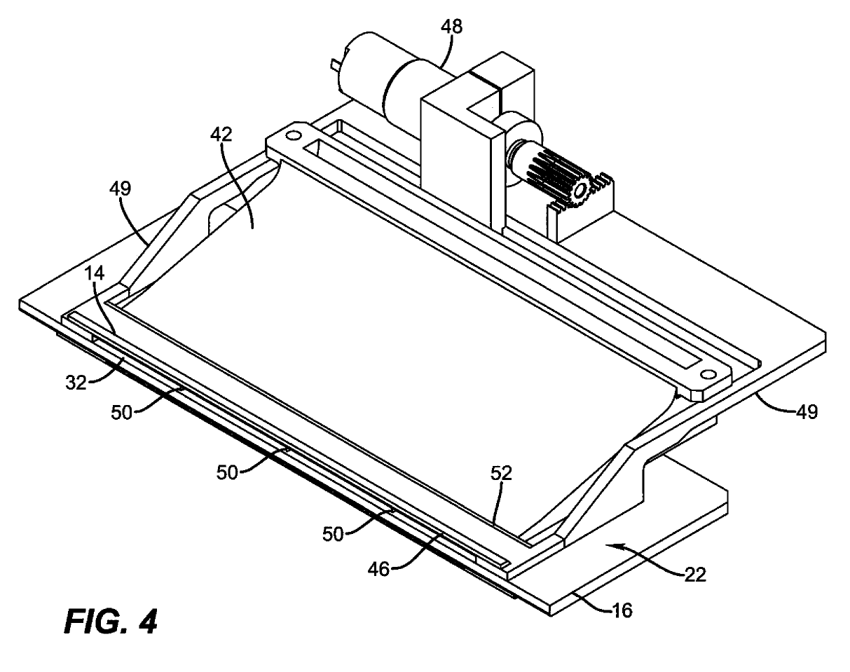

Referring to FIGS. 3, 4, and 6, and back to FIGS. 1 and 2, capping member 46 has a first position, as shown in FIG. 2 and FIG. 3, in which capping member 46 covers the nozzles of nozzle array 14. Capping member 46 also has a second position, as shown in FIGS. 1 and 4, in which capping member 46 is removed from the nozzles of nozzle array 14. Regardless of whether capping member 46 is in the first position or the second position, capping member 46 is in contact with a surface 27 of the nozzle plate 26 or nozzle array 14 in order to minimize gas leaks in printhead 10.

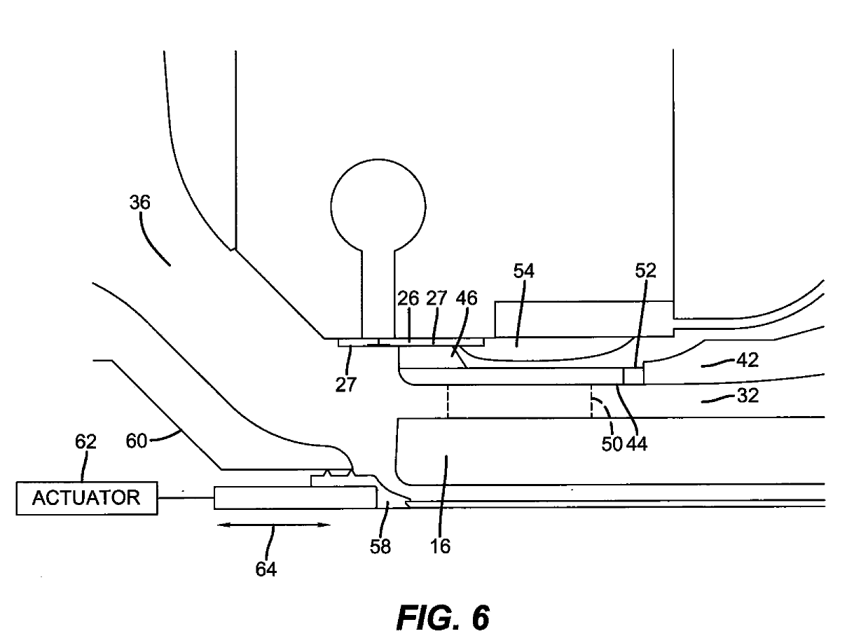

Additionally, when in the second position, as shown in FIGS. 1 and 6, the capping member 46 functions as an air dam, blocking gas flow between the gas flow duct 32 and the surface 27 of nozzle plate 26 or nozzle array 14 that might otherwise adversely affect drop deflection. The capping member 46 also can help protect the electrical connections 54 to the nozzle plate 26 by preventing ink from flowing along the nozzle plate 26 from the nozzle array 14 to the electrical connections 54.

As a gas leak between the moveable wall portion 44 and fixed wall portion 42 could adversely affect the flow of gas across the drop trajectories needed for drop deflection, an air duct seal 52 provides a seal between the moveable wall portion 44 and fixed wall portion 42 when the capping member 46 is in the second, retracted position. Air duct seal 52 positioned between moveable wall portion 44 and fixed wall portion 42 of the gas flow duct 32 helps to prevent the gas or air flow from experiencing disturbances. In a similar fashion, air duct seals can also be located between the moveable wall portion 44 and the side walls 41 to help prevent air from leaking out of or into the gas flow duct 32 at these locations.

Referring to FIGS. 3 and 4, the capping member 46 can be a replaceable component that is removably attached to the moveable wall portion 44. In these embodiments, the moveable wall portion 44 can include locating features 53 to aid in properly locating the replaceable capping member 46 relative to the remainder of the drop deflection mechanism 18. Seal 52 can also be a replaceable component. Alternatively, as shown in FIG. 4, moveable wall portion 44 can be removably attached to a coupling frame 49 portion of the capping mechanism 22 (described in more detail below). This allows moveable wall portion 44 with the attached capping member 46 and seal 52 to be replaced as a single unit or allows capping member 46 and seal 52 to be more easily serviced.

In other embodiments, moveable wall portion 44 of gas flow duct 32 can include one or more ribs 50 which are positioned along the width of the gas flow duct 32 to help support the capping member 46. Ribs 50 can extend to the opposite wall 23 of gas flow duct 32 (to the wall of catcher 16 as shown in FIG. 6) to provide maximum support, although adequate support can be attained using ribs 50 that do not extend entirely to the catcher 16. Typically, ribs 50 should be kept quite thin to minimize their disruption of the gas flow through the gas flow duct 32. Ribs 50 can be made from the same material as the duct wall, for example, a metallic or plastic material, or another material that provides adequate support. Typically, when wall 40 includes moveable wall portion 44, ribs 50 ribs are positioned adjacent or near the opening of the gas flow duct 32 proximate the area where drops deflection occurs, commonly referred to as the drop deflection zone, and extend into the gas flow duct 32 to a point not beyond the moveable wall portion 44.

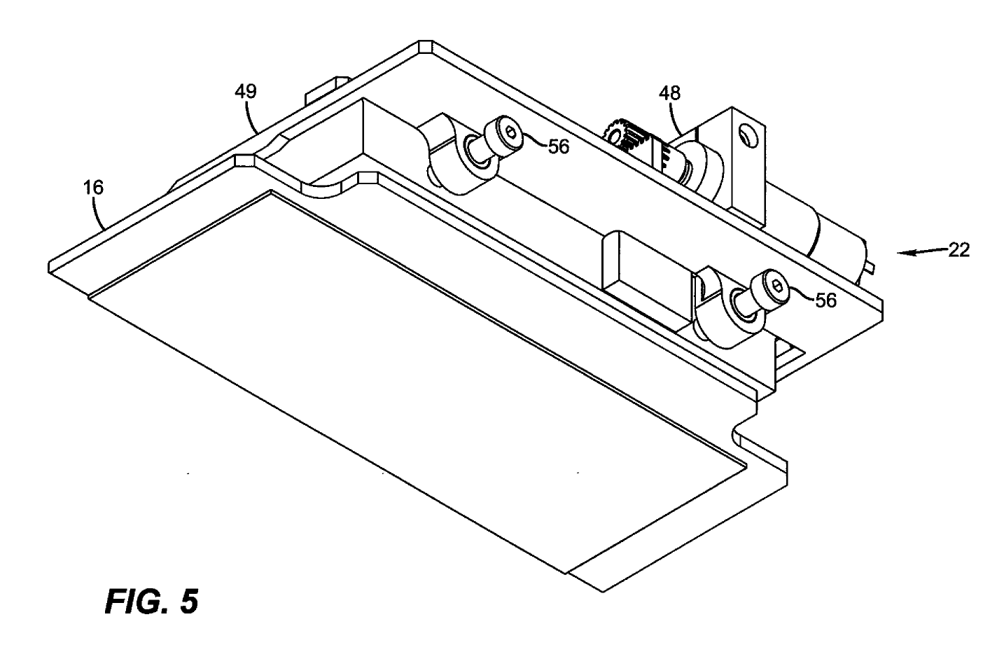

Referring to FIG. 5, and back to FIGS. 3 and 4, capping mechanism 22 includes an actuator 48 and coupling frame 49 for moving the capping member 46, along with the moveable wall portion 44 of the gas flow duct 32, between the first and second positions. Actuator 48 can be a solenoid, a motor driven mechanism, a hydraulic cylinder, or any other actuator known in the art. When actuator 48 is a motor driven mechanism, actuator 48 includes a motor operatively connected to at least one of a gear mechanism, a cam mechanism, or a linkage arm assembly. Gear mechanism, a cam mechanism, or a linkage arm assembly is also attached or otherwise operatively associated with coupling frame 49 such that actuation of actuator 48 causes moveable wall portion 44 (and capping member 46) of capping mechanism 22 to move.

As actuator 48 moves capping member 46 between the first and second positions along a path perpendicular to the initial drop trajectory 30, capping member 46 maintains contact with the surface of nozzle plate 26 and nozzle array 14. This enables capping member 46 to function as a squeegee to wipe ink and debris from the surface 27 of the nozzle array 14. Positioning coupling frame 49 between moveable wall portion 44 and actuator 48 allows actuator 48 to be somewhat removed from the area of the capping member 46 which helps keep actuator 48 clean and provides fewer space restrictions for the actuator 48. Guide rails 56 engageable with coupling frame 49 help to maintain a linear path of motion when capping mechanism 22 is moving between its first position and its second position.

Referring to FIG. 6, capping mechanism 22 can be employed in printheads that also include a sealing member 58, commonly referred to as an eyelid, that provides printhead 10 with a liquid seal below catcher 16. When sealing member 58 seals against the bottom of catcher 16, ink or cleaning liquids that flow through printhead 10 during printhead startup and/or shutdown can be contained in printhead. A second actuator 62, is used to move the sealing member 58 between sealed and unsealed locations. Actuator 62 can be a stepper motor, a solenoid, or any other actuator known to those in the art. When sealing member 58 is in a sealed location (shown in FIG. 6), it fits tight against the bottom of catcher 16 and against positive gas flow duct wall 60, preventing liquid from reaching the print media 20. When the printing system is ready to print, for example, after a cleaning or a startup sequence, actuator 62 moves the arm connected to sealing member 58 in a linear motion (represented by arrow 64), retracting the sealing member to an unsealed location. When sealing member 58 is in the unsealed position, drops ejected from the jetting module 12 can contact the print media 20 or are deflected into catcher 16 by the drop deflection mechanism 18 (shown in FIG. 1).

The invention has been described in detail with particular reference to certain preferred embodiments thereof, but it will be understood that variations and modifications can be effected within the scope of the invention.

### PARTS LIST

10 Printhead
12 Jetting module
14 Nozzle array
16 Catcher
18 Drop deflection mechanism
19 Liquid drops
20 Print media
21 Liquid drops
22 Capping mechanism
23 Wall
24 Body
26 Nozzle plate
27 Surface
28 Fluid channel
30 Initial drop trajectory
32 Gas flow duct
34 Gas flow source
36 Second gas flow duct
38 Second gas flow source
40 Wall
41 Side wall
42 Fixed wall portion
44 Moveable wall portion
45 Stimulation device
46 Capping member
48 Actuator
49 Coupling frame
50 Ribs
52 Air duct seal
53 Locating feature
54 Electrical connections
56 Guide rails
58 Sealing member
60 Positive gas flow duct wall
62 Actuator
64 Linear motion arrow

1. A printhead comprising:
a jetting module including an array of nozzles, the jetting module being operable to form liquid drops from liquid emitted through the nozzles of the nozzle array;
a catcher for collecting some of the liquid drops;
a drop deflection mechanism for deflecting the liquid drops such that some of the liquid drops contact the catcher while other liquid drops are allowed to contact a print media; and
a capping mechanism for capping the nozzle array, the capping mechanism including a capping member located between the nozzle array of the jetting module and the drop deflection mechanism, the capping member having a first position covering the nozzle array and a second position removed from the nozzle array.

2. The printhead of claim 1, the capping mechanism further comprising:
an actuator for moving the capping member between the first position and the second position.

3. The printhead of claim 2, wherein the actuator is one of a solenoid and a motor driven mechanism.

4. The printhead of claim 1, the nozzle array including a surface, wherein the capping member is in contact with the surface of the nozzle array when the capping member is in the first position and the second position.

5. The printhead of claim 1, the nozzle array including a surface, wherein the capping member maintains contact with the surface of the nozzle array as the capping member moves between the first position and the second position.

6. The printhead of claim 1, a portion of the drop deflection mechanism being moveable, wherein the capping member is affixed to the moveable portion of the drop deflection mechanism.

7. The printhead of claim 6, the drop deflection mechanism comprising a gas flow duct, the gas flow duct including a wall, wherein the moveable portion of the drop deflection mechanism includes the wall of the gas flow duct.

8. The printhead of claim 7, wherein the wall of the gas flow duct includes a rib positioned to support the capping member.

9. The printhead of claim 1, wherein the capping member includes an elastomeric material.

10. The printhead of claim 1, further comprising:
a sealing mechanism moveably positioned to create a fluid seal with the catcher.

11. A method of capping a printhead comprising:
providing a jetting module including an array of nozzles, the jetting module being operable to form liquid drops from liquid emitted through the nozzles of the nozzle array;
providing a catcher for collecting some of the liquid drops;
providing a drop deflection mechanism for deflecting the liquid drops such that some of the liquid drops contact the catcher while other liquid drops are allowed to contact a print media;
providing a capping mechanism for capping the nozzle array, the capping mechanism including a capping member located between the nozzle array of the jetting module and the drop deflection mechanism; and
moving the capping member to a first position covering the nozzle array from a second position removed from the nozzle array.

12. The method of claim 11, the nozzle array including a surface, wherein moving the capping member includes moving the capping member such that the capping member is in contact with the surface of the nozzle array when the capping member is in the first position and the second position.

13. The method of claim 11, the nozzle array including a surface, wherein moving the capping member includes moving the capping member while maintaining contact with the surface of the nozzle array as the capping member moves between the first position and the second position.

14. The method of claim 11, a portion of the drop deflection mechanism being moveable, the capping member being affixed to the moveable portion of the drop deflection mechanism, wherein moving the capping member includes moving the moveable portion of the drop deflection mechanism.
